(19) United States
(12) Patent Application Publication
(10) Pub. No.: US 2008/0213654 A1
(43) Pub. Date: Sep. 4, 2008

(54) ELECTROCHEMICAL CELL

(76) Inventor: Alex T. Fensore, Avon, OH (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 12/060,518

(22) Filed: Apr. 1, 2008

Related U.S. Application Data
(63) Continuation-in-part of application No. 10/734,518, filed on Dec. 12, 2003, now abandoned.

(51) Int. Cl. H01M 2/02; H01M 6/00

(52) U.S. Cl. 429/163; 29/623.1

(57) ABSTRACT

An alkaline electrochemical cell having a gelled anode including zinc powder and a rheological modifier is disclosed. The rheological modifier reduces at least one of the gelled anode's key rheological parameters thereby enabling transportation and distribution of the gelled anode within a battery manufacturing facility.

### CROSS REFERENCE TO RELATED APPLICATIONS

This application is a continuation-in-part of U.S. patent application Ser. No. 10/734,518, filed Dec. 12, 2003, and entitled “Electrochemical Cell.”

### BACKGROUND OF THE INVENTION

This invention generally relates to an alkaline electrochemical cell having a gelled anode. More particularly, this invention is concerned with gelled anodes that include zinc powder.

Alkaline electrochemical cells are commercially available in several standard sizes such as LR03, LR6, LR14 and LR20 which are also referred to as AAA, AA, C and D size batteries, respectively. The cells have a cylindrical shape that must comply with dimensional standards that are set by organizations such as The International Electrotechnical Commission. The cells are used by consumers to power a range of products such as cameras, compact disc players, clocks, etc. A typical cell construction includes a cylindrical container that houses a cathode, an anode and electrolyte. A separator is positioned between the cathode and the anode.

In response to consumer demand, battery manufacturers constantly strive to increase the length of time that a cell, also known herein as a battery, will power a device. The anode is one of the battery's key components that must be improved in order to provide a longer running battery. Most commercially available cylindrical alkaline batteries utilize a gelled anode mixture that includes zinc powder, a gelling agent and an alkaline electrolyte. Recent improvements to the anode have included physical and chemical changes to the zinc powder including the incorporation of zinc flakes and/or zinc “fines” in place of at least a portion of the zinc powder. Other improvements have included alloying the zinc with elements such as bismuth, indium and aluminum and/or using production processes such as centrifugal atomization, as described in WO 00/48260, to impart unique properties to the zinc powder. Additional changes have included altering the shape of the zinc particles as disclosed in WO 98/50969. Unfortunately, modifying the zinc powder to improve the battery's service performance can adversely impact the processing characteristics of the gelled anode. In some embodiments, the anode mix may become so viscous that it cannot be processed in high speed equipment used to manufacture batteries. For example, incorporating zinc flakes, as described in U.S. Pat. No. 6,022,639, or zinc fines, as described in U.S. Pat. No. 6,472,103, in an alkaline cell's gelled anode significantly increases the viscosity of the gelled anode thereby causing problems in the anode processing equipment. Similar processing problems can occur when gelled anode mixtures are stored and transported in a large container with an opening near the bottom of the container through which the anode must flow during the battery assembly process. If the anode's viscosity is too high, the anode will frequently form an arch or a void, also known as bridging, over the opening in the container thereby preventing the anode mixture from flowing through the opening. A similar problem occurs when a highly viscous anode mix must be transported in a battery manufacturing facility through pressurized piping from the anode manufacturing area to the battery assembly machine. The viscous anode is known to plug the piping thereby causing inefficiencies in the production process.

Therefore, there is a need for an alkaline cell anode that provides improved service performance and is processable through gravity feed dispensers and/or pressurized distribution systems.

### BRIEF SUMMARY OF THE INVENTION

The present invention provides an alkaline battery with a low viscosity gelled anode that includes zinc powder and provides optimum service performance.

One embodiment of this invention is an electrochemical cell that includes the following components. It comprises a container that houses a first electrode which defines a cavity therein. A separator, disposed within the cavity, lines the cavity. A second electrode is disposed within the separator lined cavity. The second electrode includes zinc powder, a rheological modifier, a gelling agent, and an electrolyte absorbed by the gelling agent. The second electrode has a preassembly yield stress less than 350 N/m² and preassembly viscosity less than 120 N·s/m² at a 2 sec⁻¹ shear rate. The second electrode's preassembly yield stress is at least 20% less than the preassembly yield stress of an identical second electrode except for the absence of the rheological modifier.

Another embodiment of this invention is an electrochemical cell that includes the following components. It comprises a container that houses a first electrode which defines a cavity therein. A separator is disposed within and lines the cavity. A second electrode is disposed within the separator-lined cavity. The second electrode includes zinc powder, a rheological modifier, a gelling agent, and an electrolyte absorbed by the gelling agent. The zinc powder includes particulate zinc having a BET specific surface area greater than 400 cm2/g, a tap density greater than 2.8 g/cc and less than 3.65 g/cc, and a D50 less than 130 microns. The second electrode has a preassembly yield stress less than 350 N/m2 and a preassembly viscosity less than 120 N·s/m2 at a 2 sec⁻¹ shear rate.

Another embodiment of the present invention is a process for making an electrochemical cell. The process includes the following steps: (a) providing a container that houses a first electrode, the first electrode defining a cavity therein; (b) disposing a separator within the cavity, where the separator lines the cavity; and (c) disposing a second electrode having a known pre-assembly yield stress into the separator lined cavity. The second electrode includes zinc particles, a rheological modifier, a gelling agent and electrolyte absorbed by the gelling agent. The second electrode has preassembly yield stress less than 350 N/m² and a preassembly viscosity less than 120 N·s/m² at a 2 sec⁻¹ shear rate. The preassembly yield stress is at least 20% less than the preassembly yield stress of an identical second electrode except for the absence of the rheological modifier.

### BRIEF DESCRIPTION OF THE DRAWINGS

FIG. 1 is a cross-sectional view of an electrochemical cell of this invention;

FIG. 2 is a chart showing the yield stress of anode mixes made with and without a rheological modifier; and

FIG. 3 is a chart showing the viscosity of anode mixes made with and without a rheological modifier.

### DESCRIPTION

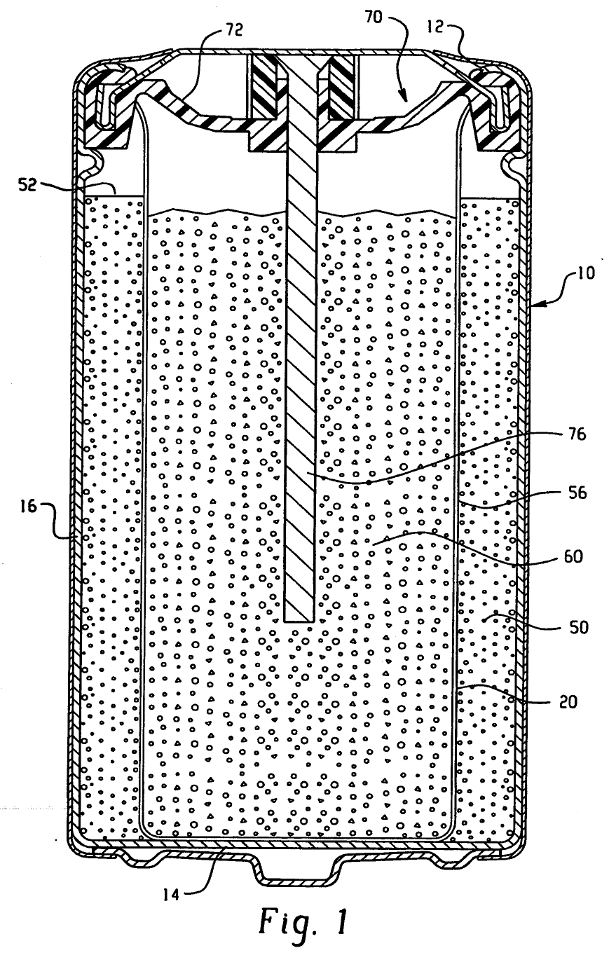

Referring now to the drawings and more particularly to FIG. 1, there is shown a cross-sectional view of an assembled electrochemical cell having an internal construction useful in cells of this invention. Beginning with the exterior of the cell, the cell components are the container 10; a first electrode 50 positioned adjacent the interior surface of container 10 and defining a cavity therein; a separator 20, located within the cavity defined by the first electrode, contacts the interior surface 56 of first electrode 50; a second electrode 60 disposed within the cavity defined by separator 20; and a closure assembly 70 secured to container 10. Container 10 has an open end 12, a closed end 14 and a sidewall 16 therebetween. The closed end 14, sidewall 16 and closure assembly 70 define an enclosed volume in which the cell's electrodes are housed.

First electrode 50, also referred to herein as the cathode, is a mixture of manganese dioxide, graphite and an aqueous solution containing potassium hydroxide. The electrode is formed by disposing a quantity of the mixture into the open ended container and then using a ram to mold the mixture into a solid tubular shape that defines a cavity which is concentric with the sidewall of the container. First electrode 50 has a ledge 52 and an interior surface 56. Alternatively, the cathode may be formed by preforming a plurality of rings from the mixture comprising manganese dioxide and then inserting the rings into the container to form the tubularly shaped first electrode. The cell shown in FIG. 1 would typically include three or four rings.

In a conventional cell, second electrode 60, also referred to herein as the anode, is a homogenous mixture of an aqueous alkaline electrolyte, zinc powder, and a gelling agent such as crosslinked polyacrylic acid. The aqueous alkaline electrolyte comprises an alkaline metal hydroxide such as potassium hydroxide, sodium hydroxide, or mixtures thereof. Potassium hydroxide is preferred. The gelling agent suitable for use in a cell of this invention can be a crosslinked polyacrylic acid, such as Carbopol 940®, which is available from Noveon, Inc., Cleveland, Ohio, USA. Carboxymethyylcellulose, polyacrylamide and sodium polyacrylate are examples of other gelling agents that are suitable for use in an alkaline electrolyte solution. The zinc powder may be pure zinc or an alloy. Furthermore, the zinc powder may include particulate zinc having irregular shapes and particle sizes as well as zinc flakes. Optional components such as gassing inhibitors (organic or inorganic anticorrosive agents), binders or surfactants may be added to the ingredients listed above. Examples of gassing inhibitors or anticorrosive agents can include indium salts (such as indium hydroxide), perfluoroalkyl ammonium salts, alkali metal sulfides, etc. Examples of surfactants can include polyethylene oxide, polyethylene alkylethers, perfluoroalkyl compounds, and the like. The second electrode may be manufactured by combining the ingredients described above into a ribbon blender or drum mixer and then working the mixture into a wet slurry.

In addition to the aqueous alkaline electrolyte absorbed by the gelling agent during the anode manufacturing process, an additional quantity of an aqueous solution of potassium hydroxide, also referred to herein as “free electrolyte,” may also be added to the cell during the manufacturing process. The free electrolyte may be incorporated into the cell by disposing it into the cavity defined by the first electrode. The method used to incorporate free electrolyte into the cell is not critical provided it is in contact with the first electrode 50, second electrode 60 and separator 20. A free electrolyte that may be used in the cell shown in FIG. 1 is an aqueous solution containing 36.5% by weight KOH.

In the bobbin-type zinc/manganese dioxide alkaline cell shown in FIG. 1, the separator 20 is commonly provided as a layered ion-permeable, non-woven fibrous fabric which separates the cathode (first electrode) from the anode (second electrode). A suitable separator is described in WO 03/043103. The separator maintains a physical dielectric separation of the positive electrode material (manganese dioxide) and the negative electrode material (zinc) and allows for the transport of ions between the electrode materials. In addition, the separator acts as a wicking medium for the electrolyte and as a collar that prevents the anode gel from contacting the top of the cathode. A typical separator usually includes two or more layers of paper. Conventional separators are usually formed either by preforming the separator material into a cup-shaped basket that is subsequently inserted into the cavity defined by the first electrode or forming a basket during cell assembly by inserting into the cavity two rectangular sheets of separator material angularly rotated ninety degrees relative to each other. The conventional preformed separators are typically made up of a sheet of non-woven fabric rolled into a cylindrical shape that conforms to the inside walls of the first electrode and has a closed bottom end.

Closure assembly 70 comprises closure member 72 and current collector 76. Closure member 72 is molded to contain a vent 82 that will allow the closure member 72 to rupture if the cell's internal pressure becomes excessive. Closure member 72 may be made from Nylon 6,6 or another material, such as a metal, provided the current collector 76 is electrically insulated from the container 10 which serves as the current collector for the first electrode. Current collector 76 is an elongated nail shaped component made of brass. Collector 76 is inserted through a centrally located hole in closure member 72.

Shown in Table 1 is the composition of a second electrode suitable for use in a cell of this invention. Except for the rheological modifier, the quantities are expressed in weight percent based on the total weight of the second electrode prior to dispensing the second electrode into the separator lined cavity.

TABLE 1

| Component | Weight Percent |
|---|---|
| Zinc powder | 68.00 |
| 32 wt % KOH solution | 31.12 |
| Zinc oxide | 0.32 |
| Sodium Silicate | 0.096 |
| Gelling agent | 0.464 |
| Rheological Modifier (ppm) | 20 |

The process for preparing the anode includes the following steps. First, one mixes the 32 weight percent KOH solution, including the ZnO and sodium silicate, with the gelling agent. The solution is absorbed by the gelling agent thereby forming a gelled electrolyte. Second, one mixes the zinc powder and rheological modifier with the gelled electrolyte under a partial vacuum. The zinc powder, gelled electrolyte and rheological modifier form a homogenous mixture wherein the zinc particles are uniformly distributed throughout the mixture.

Anodes that are suitable for use in a primary (nonrechargeable) battery having an alkaline electrolyte are typically manufactured by combining particulate zinc with a gelling agent, an aqueous alkaline solution and optional additives as described above. The quantity of zinc in the anode should be at least 60 weight percent, and more preferably, at least 65 weight percent. The quantity of gelling agent should be at least 0.30 weight percent based on the total weight of the anode. The ratio of any one ingredient to one or more of the other ingredients can be adjusted, within certain limitations, to comply with various limitations that are imposed by the processing equipment, cell design criteria such as the need to maintain particle-to-particle contact, and cost constraints. With regard to maintaining particle-to-particle contact in mercury-free batteries, which are defined herein as containing less than 50 ppm of mercury in the anode, many cell designers have specified using at least 28 volume percent zinc powder in order to maintain particle-to-particle contact between the zinc particles. However, cell designs having less than 28 volume percent zinc can be produced by including zinc flakes and/or zinc “fines” in the zinc powder in place of a portion of the particulate zinc.

Zinc powder useful in a cell of this invention may include at least one weight percent zinc flake. Two weight percent and five weight percent zinc flakes are feasible. The zinc flakes are substituted for an equivalent weight of the particulate zinc. The zinc powder may have ten weight percent or more zinc particles that will flow through a 200 mesh screen. Furthermore, the zinc powder could include zinc particles that have a bimodal distribution of particles sizes.

Particulate zinc useful in a cell of this invention may be purchased from Big River Zinc Corp. (Sauget, Ill. USA), Noranda Inc. (Toronto, Ontario Canada), Grillo-Werke (Duisburg, Germany) or N.V. UMICORE, S.A. (Brussels, Belgium). A preferred zinc may be purchased from UMICORE under the designation BIA 115. The zinc is manufactured in a centrifugal atomization process as generally described in international publication number WO 00/48260 which published on Aug. 17, 2000. This publication discloses the composition of the zinc alloy and the manufacturing process used to produce the zinc powder. However, many physical characteristics of the zinc particles are not disclosed. In a preferred embodiment, the zinc powder in a cell of this invention has many of the following physical and chemical characteristics. First, the zinc powder's particle size is characterized as having a D₅₀ median value less than 130 microns, more preferably between 100 and 130 microns, and most preferably between 110 and 120 microns. The D₅₀ median value is determined by using the sieve analysis procedure described in the American Society for Testing and Materials (ASTM) standard B214-92, entitled Standard Test Method for Sieve Analysis of Granular Metal Powders, and the reporting procedure described in ASTM D1366-86 (Reapproved 1991), entitled Standard Practice for Reporting Particle Size Characteristics of Pigments. ASTM standards B214-92 and D1366-86 (Reapproved 1991) are herein incorporated by reference. As used in this document, the zinc powder's D₅₀ median value is determined by plotting the cumulative weight percentages versus the upper class size limits data, as shown in ASTM D-1366-86, and then finding the diameter (i.e. D₅₀) that corresponds to the fifty percent cumulative weight value. Second, the zinc powder's BET specific surface area is preferably at least 400 cm²/g. More preferably, the surface area is at least 450 cm²/g. The BET specific surface area is measured on Micromeritics' model TriStar 3000 BET specific surface area analyzer with multi-point calibration after the zinc sample has been degassed for one hour at 150° C. Third, the zinc powder's tap density is preferably greater than 2.80 g/cc and less than 3.65 g/cc. More preferably, the tap density is greater than 2.90 g/cc but less than 3.55 g/cc. Most preferably, the zinc powder's tap density is greater than 3.00 g/cc and less than 3.45 g/cc. The tap density is measured using the following procedure. Fifty grams of the zinc powder are dispensed into a 50-cc graduated cylinder. The graduated cylinder containing the zinc powder is secured onto a tap density analyzer such as a model AT-2 “Auto Tap” tap density analyzer made by Quanta Chrome Corp. of Boynton Beach, Fla., U.S.A. The tap density analyzer is set to tap five hundred and twenty times. The tap density analyzer is allowed to run thereby tapping the graduated cylinder by rapidly displacing the graduated cylinder in the vertical direction five hundred and twenty times. The final volume of zinc powder in the graduated cylinder is then read. The tap density of the zinc powder can be determined by dividing the weight of the zinc powder by the volume occupied by the zinc powder after tapping. Fourth, the zinc powder has a KOH absorption value of at least 14%. More preferably, the KOH absorption value is 15% or higher. The following process can be used to determine the zinc's KOH absorption value. First, provided are a 5-cc syringe and a piece of separator that has been soaked in 32 wt % KOH and is appropriately sized to facilitate insertion of the separator into the large open end of the syringe and can be pushed through the syringe thereby blocking the smaller opening in the opposite end of the syringe. Second, the syringe and separator containing absorbed electrolyte are weighed. Third, two milliliters of a 32% by weight aqueous KOH solution are disposed into the large open end of the syringe while blocking the flow of the electrolyte through the smaller opening in the opposite end of the syringe. Fourth, a known quantity of particulate zinc, such as five grams, is carefully weighed and disposed into the open end of the syringe. The shape of the container, the volume of the solution and the volume of the zinc must be coordinated to insure that all of the zinc particles are fully submerged beneath the surface of the aqueous KOH solution. Fifth, an additional 1.5 cc of 32% by weight KOH solution is introduced into the container to ensure that the zinc is fully covered with the solution. Sixth, the KOH solution is allowed to drain through the small opening at one end of the syringe for 120 minutes by orienting the syringe in a vertical position and removing the object that blocks the small opening. To ensure that there are no droplets of unabsorbed solution trapped between the particles of zinc, the syringe is lightly tapped several times onto a paper towel until no additional KOH solution is observed landing on the paper towel. Seventh, the combined weight of the zinc with the solution adsorbed thereon, the syringe and the separator is then determined. The quantity of electrolyte solution adsorbed onto the surface of the zinc is determined by subtracting the weight of the dry zinc particles, wet separator and syringe from the combined weight of the syringe containing zinc with adsorbed electrolyte thereon and the wet separator. The KOH absorption value is determined by dividing the weight of the KOH adsorbed onto the zinc by the weight of the zinc particles prior to disposing them into the solution.

Anodes useful in a cell of this invention will now be described. In addition to the zinc powder, gelling agent, electrolyte and optional additives identified above, an anode in a cell of this invention includes a rheological property modifier. The modifier is specifically selected for its ability to change one or more of the critical rheological properties of the anode mix relative to the same properties of an identical anode mix except that the modifier is not present. Two rheological properties of the anode mix that are reduced by a rheological modifier useful in a cell of this invention are yield stress and viscosity. One or both of the values of these rheological properties must be determined after the anode mix has been manufactured and before the anode mix is conveyed from the mixing container. Consequently, as used herein, the term “preassembly,” when used in phrases such as “preassembly viscosity” or “preassembly yield stress,” refers to the values of the second electrode's respective rheological parameters after the anode mix has been manufactured and allowed to remain undisturbed for a minimum of twenty-four hours and not more than thirty-six hours. The anode's rheological parameters must be determined before the anode is distributed through piping, dispensed into moveable containers or otherwise subjected to physical stresses or changes in environmental conditions that could alter the rheological properties identified above.

Yield stress of an anode mixture is determined using a Brookfield SST controlled stress rheometer with a V40 vane spindle. The vane spindle is coated with Teflon. An anode mix's yield stress is determined using the following procedure. First, one-thousand grams of the anode mix are disposed into a 600 ml cup having a diameter of 110 mm and a height of 125 mm. The anode mix must not be shaken, stirred or agitated before it is dispensed into the cup. The top of the anode mix must be several millimeters above the top of the vane spindle. Second, the anode mix is allowed to remain undisturbed in the cup for ten minutes. Third, the rheometer is switched “on” and the stress applied by the rheometer is steadily increased from 0 N/m² to 1,700 N/m² over a five minute period. The anode's yield stress is determined by plotting the shear rate or percent strain versus the shear stress and identifying the value of the shear stress at which the slope of the curve increases significantly. The anode mix's yield stress correlates to the amount of pressure needed to start the anode mix flowing through horizontal piping in an anode distribution system used in a battery manufacturing facility. As the anode mix's yield stress increases, the amount of pressure needed to start the anode mix moving through the piping also increases. If the anode's yield stress is too high, conventional equipment may not be able to pump the anode through the piping. Preferably, anode mixes useful in a cell of this invention have a yield stress less than 350 N/m². More preferably, the anode mix has a yield stress less than 300 N/m² and greater than 100 N/m².

Shown in Table 2 are the formulas that were used to make eight anode mixes designated A, B, C, D, E, F and G. The quantities are expressed in weight percent based on the total weight of the second electrode, as represented by lot A, prior to dispensing the second electrode into the separator lined cavity. In lots B, C, D, E, F and G the quantity of rheological modifier in each mix is expressed in parts per million based on the weight of the zinc. Lot A is the only lot that contained no rheological modifier. Lots B through G were made exactly like lot A except that the quantities of rheological modifier specified in Table 2 were added to each lot.

TABLE 2

| | A | B | C | D | E | F | G | H |
|---|---|---|---|---|---|---|---|---|
| Zinc* | 68.00 | 68.00 | 68.00 | 68.00 | 68.00 | 68.00 | 68.00 | 68.00 |
| Electrolyte | 31.12 | 31.12 | 31.12 | 31.12 | 31.12 | 31.12 | 31.12 | 31.12 |
| Zinc Oxide | 0.32 | 0.32 | 0.32 | 0.32 | 0.32 | 0.32 | 0.32 | 0.32 |
| Sodium Silicate | 0.096 | 0.096 | 0.096 | 0.096 | 0.096 | 0.096 | 0.096 | 0.096 |
| Gelling Agent | 0.464 | 0.464 | 0.464 | 0.464 | 0.464 | 0.464 | 0.464 | 0.464 |
| Modifier | 0 | 1 | 10 | 20 | 40 | 60 | 80 | 100 |
| (ppm) | | | | | | | | |
| Yield Stress (N/m²) | 1258 | 176 | 201 | 158 | 145 | 152 | 144 | 142 |

*purchased from UMICORE, designated BIA 115

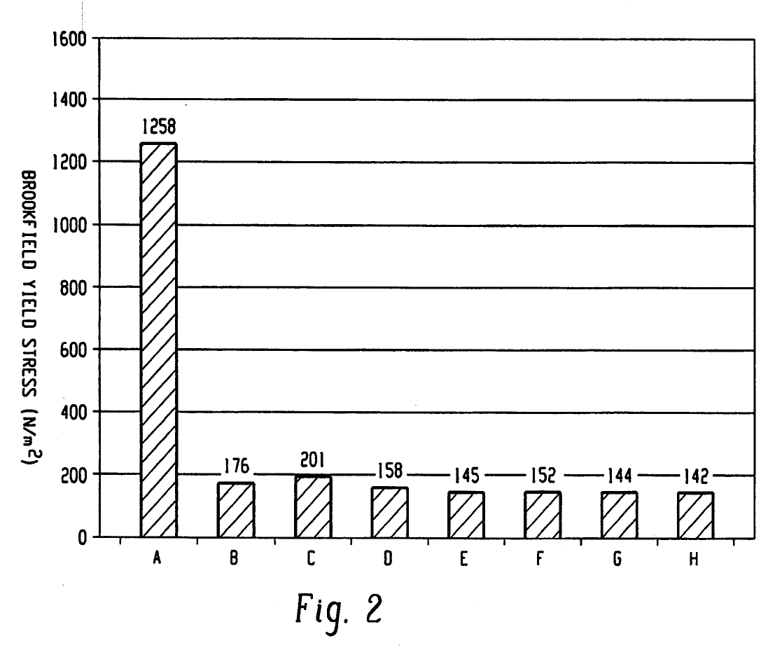

As can be seen by examining the yield stress data listed in Table 2 and illustrated in FIG. 2, incorporating a rheological modifier into the anode mix decreased the yield stress of the anode relative to the yield stress of an otherwise identical anode mix except for the absence of the modifier. Modifiers that cause at least a 20% decrease in the anode mix's yield stress are preferred. Modifiers that can reduce the anode mix's yield stress by at least 40%, 60% or 80% are more preferred.

The viscosity of an anode mix is another rheological parameter of the anode mix and is measured using a Brookfield SST rheometer and a V40 vaned spindle. The anode mix must not be stirred, shaken or agitated before measuring the viscosity. The viscosity can be measured by applying a 2 sec⁻¹ shear rate to the anode for two minutes and then recording the viscosity value. The shear rate at which the viscosity is measured is a critical parameter of the viscosity measurement. The viscosity of an anode mix is an indication of the mix's resistance to flow in horizontal piping. The higher the viscosity, the greater the resistance to flowing. If the viscosity is too high, the anode mix cannot be distributed through horizontal piping without applying excessive pressure on the mix. The use of excessive pressure can cause problems such as squeeze out of the electrolyte from the gelling agent which leads to the formation of “knots” in the piping. The knots plug the pipes thereby stopping the flow of any anode mix through the piping.

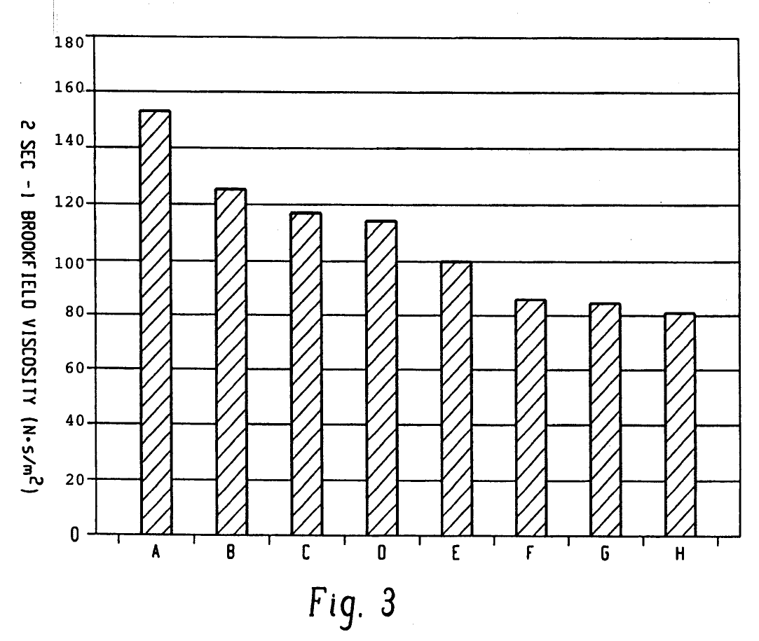

The viscosity data illustrated in FIG. 3 shows that including a rheological modifier in the anode formulas caused the viscosity of the anode mix to drop from more than 140 N·s/m² at a 2 sec⁻¹ shear rate to less than 120 N·s/m² at a 2 sec⁻¹ shear rate. Preferably, a modifier useful in a cell of this invention causes at least a 15% reduction, more preferably a 30% reduction and most preferably a 40% reduction in the anode mix's viscosity. The viscosity of the anode mix is preferably less than 110 N·s/m² at a 2 sec⁻¹ shear rate, more preferably less than 100 N·s/m² at a 2 sec⁻¹ shear rate and most preferably less than 90 N·s/m² at a 2 sec⁻¹ shear rate and greater than 65 N·s/m² at a 2 sec⁻¹ shear rate.

Rheological modifiers useful in a cell of this invention must be stable in an alkaline electrolyte, such as an aqueous solution that includes 45% by weight potassium hydroxide and cannot cause excessive gassing within the cell that could lead to venting of cell's seal and leakage of the electrolyte.

Examples of rheological modifiers useful in a cell of this invention include Stepfac 8173®, also known as Polystep P33, and Stepfac 8170® which are commercially available materials supplied by Stepan Chemicals located in Northfield, Ill., USA. These modifiers are nonylphenol ethoxylate phosphates. Stepfac 8173®, which is composed of approximately 60% monoester, 30% diester and 3% phosphoric acid, was used in the anode mixes shown in Table 2. Stepfac 8170® is composed of approximately 50% monoester, 45% diester and 3% phosphoric acid. Other suitable rheological modifiers are surfactants manufactured by BYK Chemie, located in Germany, and sold commercially as Disperbyk 190® and Disperbyk 102®. Another suitable rheological modifier is QS-44® which is commercially available from DOW Chemical in Midland, Mich.

A process for manufacturing an electrochemical cell of this invention includes the following steps. In one step, a container is provided. The container houses a first electrode which defines a cavity therein. A suitable container is a nickel plated steel can that is closed on one end and open on the other end. Preferably, the cavity is centrally located within the container. In another step, a separator is inserted into the cavity defined by the first electrode. The separator lines the cavity. The separator forms an elongated basket with a closed end located near the closed end of the container and an open end located near the open end of the container. In another step, a second electrode is disposed into the separator lined cavity. Prior to disposing the second electrode into the separator lined cavity, the second electrode is manufactured by forming a homogenous mixture including zinc powder, a rheological modifier, a gelling agent and an electrolyte absorbed by the gelling agent. The mixture, prior to subjecting it to forces or environmental conditions that could alter its key rheological properties, has a preassembly yield stress less than 350 N/m² and preferably a preassembly viscosity less than 120 N·s/m² at a 2 sec⁻¹ shear rate. The yield stress is at least 20% less than the preassembly yield stress of an identical second electrode except for the absence of the rheological modifier. A closure assembly may be secured to the container after the second electrode has been inserted.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the Doctrine of Equivalents.

I claim:

1. An electrochemical cell, comprising:
a) a container housing a first electrode, said electrode defining a cavity therein;
b) a separator lining said cavity and abutting said first electrode; and
c) a second electrode disposed within said separator lined cavity, said second electrode comprising zinc powder, a rheological modifier, a gelling agent, and an electrolyte absorbed by the gelling agent, said second electrode having a preassembly yield stress less than 350 N/m² and a preassembly viscosity less than 120 N·s/m² at a 2 sec⁻¹ shear rate, said preassembly yield stress is at least 20% less than the preassembly yield stress of an identical second electrode except for the absence of said rheological modifier.

2. The electrochemical cell of claim 1, wherein said second electrode's preassembly yield stress is less than 300 N/m² and greater than 100 N/m².

3. The electrochemical cell of claim 1, wherein said second electrode's preassembly viscosity is less than 110 N·s/m² at a 2 sec⁻¹ shear rate.

4. The electrochemical cell of claim 3, wherein said second electrode's preassembly viscosity is less than 100 N·s/m² at a 2 sec⁻¹ shear rate.

5. The electrochemical cell of claim 4, wherein said second electrode's preassembly viscosity is less than 90 N·s/m² at a 2 sec⁻¹ shear rate.

6. The electrochemical cell of claim 1, wherein said second electrode's preassembly viscosity is at least 15% less than the preassembly viscosity of an identical second electrode except for the absence of said rheological modifier.

7. The electrochemical cell of claim 6, wherein said second electrode's preassembly viscosity is at least 30% less than the preassembly viscosity of an identical second electrode except for the absence of said rheological modifier.

8. The electrochemical cell of claim 7, wherein said second electrode's preassembly viscosity is at least 40% less than the preassembly viscosity of an identical second electrode except for the absence of said rheological modifier.

9. The electrochemical cell of claim 1, wherein said preassembly yield stress is at least 40% less than the preassembly yield stress of an identical second electrode except for the absence of said rheological modifier.

10. The electrochemical cell of claim 9, wherein said preassembly yield stress is at least 60% less than the preassembly yield stress of an identical second electrode except for the absence of said rheological modifier.

11. The electrochemical cell of claim 10, wherein said preassembly yield stress is at least 80% less than the preassembly yield stress of an identical second electrode except for the absence of said rheological modifier.

12. The electrochemical cell of claim 1, wherein said second electrode comprises at least 60 wt % zinc powder.

13. The electrochemical cell of claim 12, wherein said second electrode comprises at least 0.30 wt % gelling agent.

14. The electrochemical cell of claim 13, wherein said second electrode comprises an aqueous alkaline solution.

15. The electrochemical cell of claim 1, wherein the quantity of said modifier is less than 400 ppm and greater than 10 ppm less based on the weight of the zinc powder.

16. The electrochemical cell of claim 15, wherein the quantity of said modifier is less than 100 ppm and greater than 10 ppm based on the weight of the zinc powder.

17. The electrochemical cell of claim 16, wherein the quantity of said modifier is less than 40 ppm and greater than 10 ppm based on the weight of the zinc powder.

18. The electrochemical cell of claim 17, wherein the quantity of said modifier is less than 20 ppm and greater than 10 ppm based on the weight of the zinc powder.

19. The electrochemical cell of claim 1, wherein said zinc powder comprises at least 1 weight percent zinc flakes based on the total weight of the zinc powder.

20. The electrochemical cell of claim 19, wherein said zinc powder comprises at least 2 weight percent zinc flakes based on the total weight of the zinc powder.

21. The electrochemical cell of claim 20, wherein said zinc powder comprises at least 5 weight percent zinc flakes based on the total weight of the zinc powder.

22. The electrochemical cell of claim 1, wherein at least 10 wt % of said zinc powder is sized to pass through a 200 mesh screen.

23. The electrochemical cell of claim 1, wherein said zinc powder has a bimodal distribution of particle sizes.

24. An electrochemical cell, comprising:
a) a container housing a first electrode, said electrode defining a cavity therein;
b) a separator lining said cavity and abutting said first electrode; and
c) a second electrode disposed within said separator lined cavity, said second electrode comprising zinc powder, a rheological modifier, a gelling agent, and an electrolyte absorbed by the gelling agent, said zinc powder comprising particulate zinc having a BET specific surface area greater than 400 cm²/g, a tap density greater than 2.8 g/cc and less than 3.65 g/cc, and a D₅₀ less than 130 microns, said second electrode having a preassembly yield stress less than 350 N/m² and a preassembly viscosity less than 120 N·s/m² at a 2 sec⁻¹ shear rate.

25. The electrochemical cell of claim 24 wherein said zinc powder has a KOH absorption value greater than 14%.

26. The electrochemical cell of claim 25 wherein said zinc powder has a KOH absorption value greater than 15%.

27. The electrochemical cell of claim 24 wherein said second electrode comprising a rheological modifier has a preassembly yield stress less than 300 N/m².

28. The electrochemical cell of claim 18 wherein said second electrode comprising a rheological modifier has a viscosity less than 110 N·s/m² at a 2 sec⁻¹ shear rate.

29. The electrochemical cell of claim 22 wherein said second electrode comprising a rheological modifier has a viscosity less than 100 N·s/m² at a 2 sec⁻¹ shear rate.

30. The electrochemical cell of claim 24 wherein the quantity of said modifier is less than 400 ppm and greater than 10 ppm based on the weight of said zinc.

31. The electrochemical cell of claim 30, wherein the quantity of said modifier is less than 100 ppm and greater than 10 ppm based on the weight of the zinc.

32. The electrochemical cell of claim 31, wherein the quantity of said modifier is less than 40 ppm and greater than 10 ppm based on the weight of the zinc.

33. The electrochemical cell of claim 32, wherein the quantity of said modifier is less than 20 ppm and greater than 10 ppm based on the weight of the zinc.

34. A process for manufacturing an electrochemical cell, comprising the steps of:
a) providing a container housing a first electrode, said first electrode defining a cavity therein;
b) inserting a separator into said cavity, said separator lining said cavity;
c) disposing a second electrode into the separator lined cavity, said second electrode comprising zinc powder, a rheological modifier, a gelling agent, and an electrolyte absorbed by the gelling agent, said second electrode having a preassembly yield stress less than 350 N/m² and a preassembly viscosity less than 120 N·s/m² at a 2 sec⁻¹ shear rate, said yield stress is at least 20% less than the preassembly yield stress of an identical second electrode except for the absence of said rheological modifier.

35. The process of claim 34, further including the step of securing a closure assembly to said container.

36. The process of claim 34, wherein said preassembly yield stress is less than 300 N/m².

37. The process of claim 34, wherein said preassembly viscosity is less than 110 N·s/m² at a 2 sec⁻¹ shear rate.

38. The process of claim 34, wherein said preassembly viscosity is less than 100 N·s/m² at a 2 sec⁻¹ shear rate.

39. The process of claim 34, wherein said preassembly viscosity is less than 90 N·s/m² at a 2 sec⁻¹ shear rate.

40. The process of claim 34, wherein said preassembly yield stress is at least 40% less than the preassembly yield stress of an identical second electrode except for the absence of said rheological modifier.

41. The process of claim 40, wherein. said preassembly yield stress is at least 60% less than the preassembly yield stress of an identical second electrode except for the absence of said rheological modifier.

42. The process of claim 41, wherein said preassembly yield stress is at least 80% less than the preassembly yield stress of an identical second electrode except for the absence of said rheological modifier.

43. The process of claim 34, wherein said second electrode's preassembly viscosity is at least 15% less than the preassembly viscosity of an identical second electrode except for the absence of said rheological modifier.

44. The process of claim 43, wherein said second electrode's preassembly viscosity is at least 30% less than the preassembly viscosity of an identical second electrode except for the absence of said rheological modifier.

45. The process of claim 44, wherein said second electrode's preassembly viscosity is at least 40% less than the preassembly viscosity of an identical second electrode except for the absence of said rheological modifier.

46. An electrochemical cell, comprising:
a) a container housing a first electrode, said electrode defining a cavity therein;
b) a separator lining said cavity and abutting said first electrode; and
c) a second electrode disposed within said separator lined cavity, said second electrode comprising zinc powder, a rheological modifier, a gelling agent, and an electrolyte absorbed by the gelling agent, said second electrode having a preassembly yield stress less than 350 N/m², said preassembly yield stress is at least 20% less than the preassembly yield stress of an identical second electrode except for the absence of said rheological modifier.

47. The electrochemical cell of claim 46, wherein said second electrode's preassembly yield stress is less than 300 N/m² and greater than 100 N/m².

48. The electrochemical cell of claim 46, wherein said preassembly yield stress is at least 40% less than the preassembly yield stress of an identical second electrode except for the absence of said rheological modifier.

49. The electrochemical cell of claim 46, wherein said preassembly yield stress is at least 60% less than the preassembly yield stress of an identical second electrode except for the absence of said rheological modifier.

50. The electrochemical cell of claim 46, wherein said preassembly yield stress is at least 80% less than the preassembly yield stress of an identical second electrode except for the absence of said rheological modifier.

51. A process for manufacturing an electrochemical cell, comprising the steps of:
a) providing a container housing a first electrode, said first electrode defining a cavity therein;
b) inserting a separator into said cavity, said separator lining said cavity;
c) disposing a second electrode into the separator lined cavity, said second electrode comprising zinc powder, a rheological modifier, a gelling agent, and an electrolyte absorbed by the gelling agent, said second electrode having a preassembly yield stress less than 350 N/m², said yield stress is at least 20% less than the preassembly yield stress of an identical second electrode except for the absence of said rheological modifier.

52. The process of claim 51, wherein said preassembly yield stress is less than 300 N/m².

53. The process of claim 51, wherein said preassembly yield stress is at least 40% less than the preassembly yield stress of an identical second electrode except for the absence of said rheological modifier.

54. The process of claim 51, wherein. said preassembly yield stress is at least 60% less than the preassembly yield stress of an identical second electrode except for the absence of said rheological modifier.

55. The process of claim 51, wherein said preassembly yield stress is at least 80% less than the preassembly yield stress of an identical second electrode except for the absence of said rheological modifier.
